(19) United States
(12) Patent Application Publication
(10) Pub. No.: US 2015/0107106 A1
(43) Pub. Date: Apr. 23, 2015

(54) METHOD FOR PRODUCING A PISTON WITH A COOLING DUCT

(71) Applicants: Ralf Buschbeck, Neudenau (DE); Emmerich Ottliczky, Forchtenberg-Ernsbach (DE)

(72) Inventors: Ralf Buschbeck, Neudenau (DE); Emmerich Ottliczky, Forchtenberg-Ernsbach (DE)

(73) Assignee: KS KOLBENSCHMIDT GMBH, Neckarsulm (DE)

(21) Appl. No.: 14/400,217

(22) PCT Filed: May 8, 2013
(86) PCT No.: PCT/EP2013/059657

§ 371 Date: Nov. 10, 2014

(30) Foreign Application Priority Data
May 11, 2012 (DE) 10 2012 207 961.0

(51) Int. Cl. B23P 15/10

(52) U.S. Cl. CPC B23P 15/10
USPC 29/888.04

(57) ABSTRACT

A method for producing a piston with a cooling duct for an internal combustion engine, wherein a piston blank is provided with a collar protruding beyond the outer diameter of the later formed piston, and is formed on the piston blank by forging, spin-bending or the like. To form the cooling duct, a radially peripheral recess is introduced into the piston blank by forging, spin-bending or the like. In a further method step, a forming operation is performed on the collar, which together with the peripheral recess forms the cooling duct.

### BACKGROUND

The disclosure relates to a method for producing a piston with a cooling duct and a piston with a cooling duct for internal combustion engines.

Producing a piston blank at least partially, or entirely, by forging is known from EP 1 452 250 A2. In this process, the functional elements of the piston, such as the piston crown, piston skirts, piston bosses, piston pin bore, are introduced into the piston blank.

In the prior art, a peripheral collar is similarly produced by forging in the area of the top land that is present in the finished piston, approximately at the level of the first groove. The geometric shape of this collar is selected such that sufficient material is available to close the recess, still to be introduced, that later forms a cooling duct. Above or below the collar, a recess with its upper and lower vertex radius and the inner wall is incorporated into the piston blank by machining and the collar is suitably shaped for closing the recess after the machined collar is formed.

It is disadvantageous in this process to weaken the intrinsically strong microstructure achieved in the forging process by introducing the recess through machining. In addition, material is lost from the piston blank as a result of the machining, which has a negative effect on production costs.

It would be desirable, to improve a corresponding process and a piston with cooling duct produced in accordance therewith.

### SUMMARY

The process provides for the piston blank to be produced at least partially or entirely, with its functional elements by forging, as known in the prior art. As a result of the forging process, a material microstructure is achieved that fulfills the requirements of a modern piston with a cooling duct for operation in an internal combustion engine.

In accordance with the disclosure, provision is made for the recess not to be introduced into the piston blank by machining; but for the recess to be introduced as well by forging or by a comparable process (such as spin-bending, pressing or similar). As a result, at least a clearly reduced amount of waste material ensues, which results in correspondingly reduced costs since, at least, this sharply reduced amount of waste material has to be recycled. It is additionally advantageous that the method is carried out in such a manner that, with or through the introduction of the recess into the piston blank, the formable radially peripheral collar is created at the same time. After producing a piston blank of this type, the radially peripheral collar thus created and projecting beyond the outer diameter of the piston blank can be formed in such a manner that it closes the recess, resulting in the creation of a cooling duct that is located in the piston crown. Since the machining to produce the radially peripheral recess (that forms the later cooling duct) is dispensed with, at least to a large degree, the material microstructure achieved in the forging process is advantageously retained and not, as in the prior art, weakened by machining.

The collar projecting beyond the outer diameter of the piston with a cooling duct can be formed on the piston blank by forging, spin-bending or similar.

The formation of the collar can be carried out by forging, spin-bending, a calibration procedure or similar.

In what follows, the procedural steps for producing a piston with a cooling duct are listed as examples.

Production of a single-piece piston with a cooling duct forged blank without an undercut;

Creation of a collar projecting beyond the diameter of the piston with a cooling duct, and the creation of the recess to form the later cooling duct in the same procedural step;

Alternatively, creation of the recess in a separate procedural step;

Closing the recess by forming the collar to create a cooling duct;

Introduction of the ring grooves and the addition of the top land.

In a further aspect of the method, the recess for later forming the cooling duct is introduced into the piston blank by forging, spin bending or similar without the collar being formed simultaneously.

When carrying out the method the collar can be positioned flush with the piston crown or flush with the upper edge of the piston skirt.

Ring grooves, specifically to receive piston rings, can be located at the formed collar and/or on the base piston body.

The ring grooves and at least one top land can be formed as the collar is being formed to create the cooling duct, or when the cooling duct is closed. It is also conceivable to make provision for producing the grooves at the time the collar is created.

After the cooling duct has been formed, the ring grooves and the at least one top land can be machined from the cooling duct piston forged blank by turning or similar.

The geometry of the cooling duct is created at least partially, or in its entirety, before the cooling duct is closed. Suitable methods for creating the recess and for closing the recess to form the cooling duct are, for example, forging, rolling, or spin-bending.

Pistons produced by forging have greater strength than pistons produced by casting; the method maintains this advantage even in the area of the later formed cooling duct. Machining procedures such as those known from the prior art result in a change in the material microstructure and thus a weakening in the machining area; this is avoided or minimized by the method.

### BRIEF DESCRIPTION OF THE DRAWING

In the drawing:

FIG. 1 shows a schematic representation of a piston with a cooling duct forged blank;

FIG. 2 shows a schematic representation of a piston with a cooling duct forged blank after the recess is introduced and simultaneous forming of the collar;

FIG. 3 shows a schematic representation of a piston with a cooling duct after completion of the cooling duct; and

FIG. 4 shows a schematic representation of a piston with cooling a duct after the ring grooves have been introduced.

### DETAILED DESCRIPTION

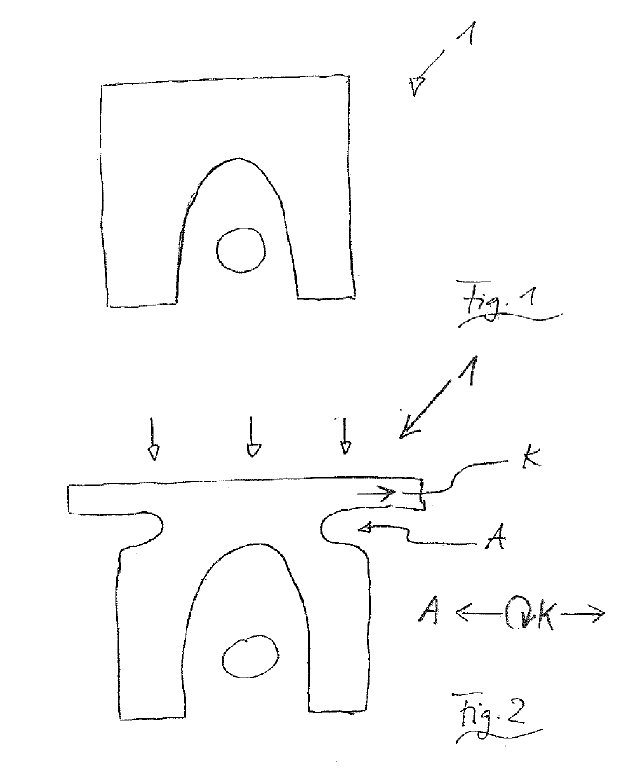

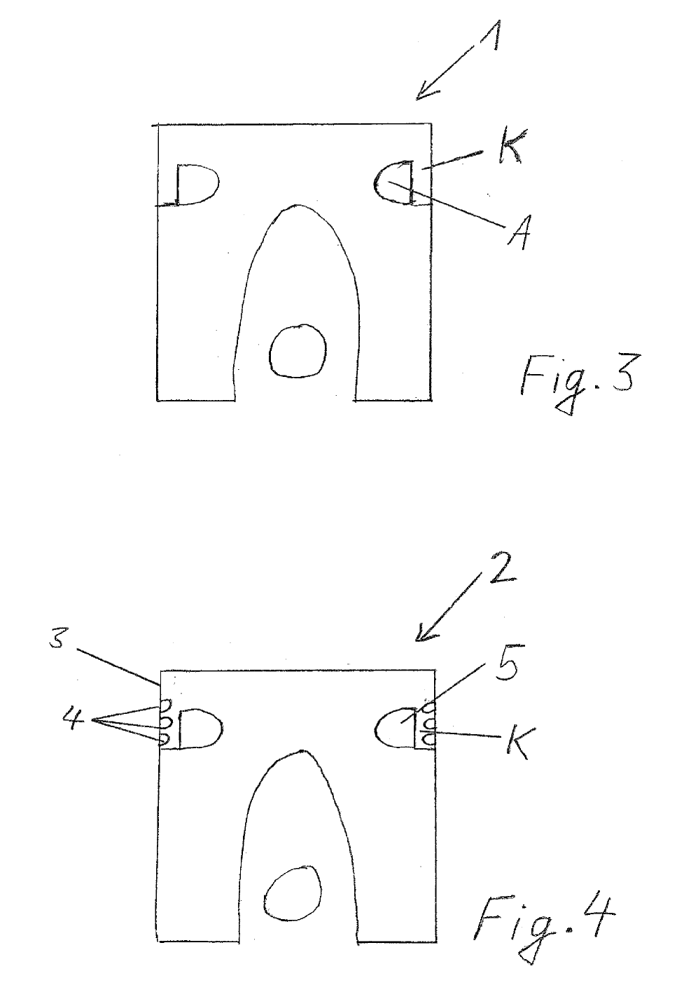

The method is shown in principle in FIGS. 1 to 4. FIG. 1 shows a piston blank 1 that is produced by forging. Functional elements of the later piston, such as piston crown, piston skirts, piston bosses, piston pin bore and the like are introduced at the same time. Since the later, finished piston is to be a piston with a cooling duct, a recess A is introduced into the piston blank 1 as shown in FIG. 2. This radially peripheral recess A is introduced by forging, spin-bending or similar. The procedure to introduce the recess A is carried out in such manner that a radially peripheral collar K (also designated as a flange) projecting beyond the outer diameter of the piston blank is created.

In accordance with FIG. 2, the recess A is introduced into the piston blank 1 in such a manner that when viewing FIG. 2 the collar K is created above the recess A. In order for this to be possible, a counter-force must be applied from above, for example. by a plate (similarly when viewing FIG. 2). This means that the tool with which the radially peripheral recess A is introduced into the piston blank operates so that it displaces the material of the piston blank towards the piston stroke axis, and simultaneously the radially peripheral collar K assumes a shape like the one shown in FIG. 2. In order for the desired design of the collar K to be realized thereby and so that the material of the piston blank is not pushed upward, it is necessary to employ a counter-support (e.g. a plate), which is indicated in FIG. 2 by the three downward pointing arrows.

After the piston blank has been given a shape as shown in principle in FIG. 2, the radially peripheral collar K is formed so that it closes the recess A. These procedural steps can be found in the prior art (EP 1 452 250 A2). After the initially outward projecting collar K has been folded over to close the recess A, it can be, but does not have to be, permanently joined to the piston blank with its peripheral lower edge. Production of a cooling duct 5 on a piston with cooling duct 2 is now complete. A top land 3 and ring grooves 4 are formed subsequently in the piston blank, so that a piston with a cooling duct 2 is created. The last step is final machining of the piston blank produced in this way so that a ready-to-use piston with a cooling duct for use in a cylinder of the internal combustion engine is created.

1. A method for producing a piston with cooling duct for an internal combustion engine, having a cooling duct in a crown, wherein a piston blank is provided and a collar projecting beyond an outer diameter of a later formed piston is formed on the piston blank by one of forging, spin-bending or the like, and to create the cooling duct radially peripheral recess is introduced into the piston blank characterized in that the radially peripheral recess is introduced by one of forging, spin-bending or the like into the piston blank and the cooling duct is formed by forming the collar in conjunction with the radially peripheral recess.

2. The method from claim 1, wherein the method for introducing the recess is performed in such manner that the collar is formed as a radially peripheral collar projecting beyond the outer diameter of the piston blank.

3. The method from claim 1, wherein the forming of the collar is carried out by one of forging, spin-bending, calibration or the like.

4. The method from claim 1 wherein the collar to form the cooling duct positioned against a contact area.

5. The method from claim 1, wherein the collar to form the cooling duct is positioned against an at least partially peripheral flange to determine the position of the collar after forming.

6. The method from claim 5, wherein the collar is permanently attached at the peripheral flange after being formed.

7. The method from claim 1, wherein the recess is introduced into the piston blank by one of forging, spin-bending or the like without the collar being formed at the same time.

8. The method from claim 1, wherein the position of the collar is set flush with one of the crown or an upper edge of a piston skirt.

9. A piston with a cooling duct produced in accordance with the method of claim 1.

10. The piston with a cooling duct from claim 9, wherein functional elements of the later formed piston with a cooling duct comprise a piston crown, piston skirts, piston bosses, and piston pin bores.

11. A method for producing a piston with a cooling duct in a crown comprising:
providing a piston blank;
forming a collar projecting beyond an outer diameter of a later formed piston on the piston blank by one of forging and spin-bending;
introducing a radially peripheral recess in the piston blank by one of forging and spin-bending; and
forming the cooling duct by forming the collar in conjunction with the radially peripheral recess.
